(19) United States
(12) Patent Application Publication
(10) Pub. No.: US 2012/0151341 A1
(43) Pub. Date: Jun. 14, 2012

(54) Interactive Screen Saver Method and Apparatus

(76) Inventors: Steve S. Ko, San Francisco, CA (US); John W. Scalo, Santa Cruz, CA (US)

(21) Appl. No.: 12/965,629

(22) Filed: Dec. 10, 2010

(51) Int. Cl. G06F 3/048

(52) U.S. Cl. 715/716; 715/867

(57) ABSTRACT

An apparatus and computer-implemented method are described for an interactive screen saver. For example, a method according to one embodiment of the invention comprises: initiating a screen saver on a data processing device; detecting keyboard input and/or mouse input on the data processing device while the screen saver is running; determining whether the screen saver is a keyboard interactive and/or a mouse interactive screen saver; if the interactive screen saver is keyboard interactive and/or mouse interactive, then performing interactive operations within the interactive screen saver in response to user input entered from the keyboard and/or mouse, respectively without quitting the screen saver; and if the interactive screen saver is not keyboard and/or mouse interactive, then quitting the interactive screen saver in response to detecting the keyboard input and/or mouse input.

### BACKGROUND

1. Field of the Invention

This invention relates generally to the field of computer systems. More particularly, the invention relates to an interactive screen saver method and apparatus.

2. Description of the Related Art

A screen saver is a well known type of computer program which typically generates graphical images on a computer's display after a specified period of inactivity. Historically, screen savers were designed to prevent phosphor burn-in on CRT and plasma computer monitors by blanking the screen or filling it with moving images when the computer is not in use. Because modern CRTs and liquid crystal display (LCD) computer monitors are much less susceptible to burn-in, screensavers today are primarily decorative or for entertainment, and usually feature moving images or patterns and sometimes sound effects.

FIG. 1 illustrates one particular screen saver designed by the assignee of the present patent application in which the display is randomly filled with “album art” from a user's music collection. As illustrated, the album images 101 are collected from the user's music database and displayed in a tiled format. A random album image is periodically replaced with a new, randomly-selected image from the user's music collection. The end user may configure variables such as the delay before the screen saver is initialized, the frequency with which existing album images are replaced, and the number of rows of album images 101 to be displayed.

### SUMMARY

An apparatus and computer-implemented method are described for an interactive screen saver. For example, a method according to one embodiment of the invention comprises: initiating a screen saver on a data processing device; detecting keyboard input and/or mouse input on the data processing device while the screen saver is running; determining whether the screen saver is a keyboard interactive and/or a mouse interactive screen saver; if the interactive screen saver is keyboard interactive and/or mouse interactive, then performing interactive operations within the interactive screen saver in response to user input entered from the keyboard and/or mouse, respectively without quitting the screen saver; and if the interactive screen saver is not keyboard and/or mouse interactive, then quitting the interactive screen saver in response to detecting the keyboard input and/or mouse input.

### BRIEF DESCRIPTION OF THE DRAWINGS

A better understanding of the present invention can be obtained from the following detailed description in conjunction with the following drawings, in which:

FIG. 1 illustrates a prior art screen saver which utilizes album art from a user's music collection.

FIG. 2 illustrates a system architecture according to one embodiment of the invention.

FIG. 3 illustrates one embodiment of an interactive screen saver method.

FIG. 4 illustrates one embodiment of an interactive screen saver method utilizing album art and music content.

FIGS. 5-6 illustrate one embodiment of an interactive screen saver utilizing album art and music content.

FIG. 7 illustrates one embodiment of an interactive screen saver method utilizing a photo collection.

FIGS. 8-10 illustrate one embodiment of an interactive screen saver utilizing a photo collection.

FIG. 11 illustrates a block diagram of an exemplary API architecture useable in some embodiments of the present invention.

FIG. 12 shows an exemplary embodiment of a software stack useable in some embodiments of the present invention.

FIG. 13 shows, in block diagram form, an example of a data processing system which can be used with one or more embodiments described herein.

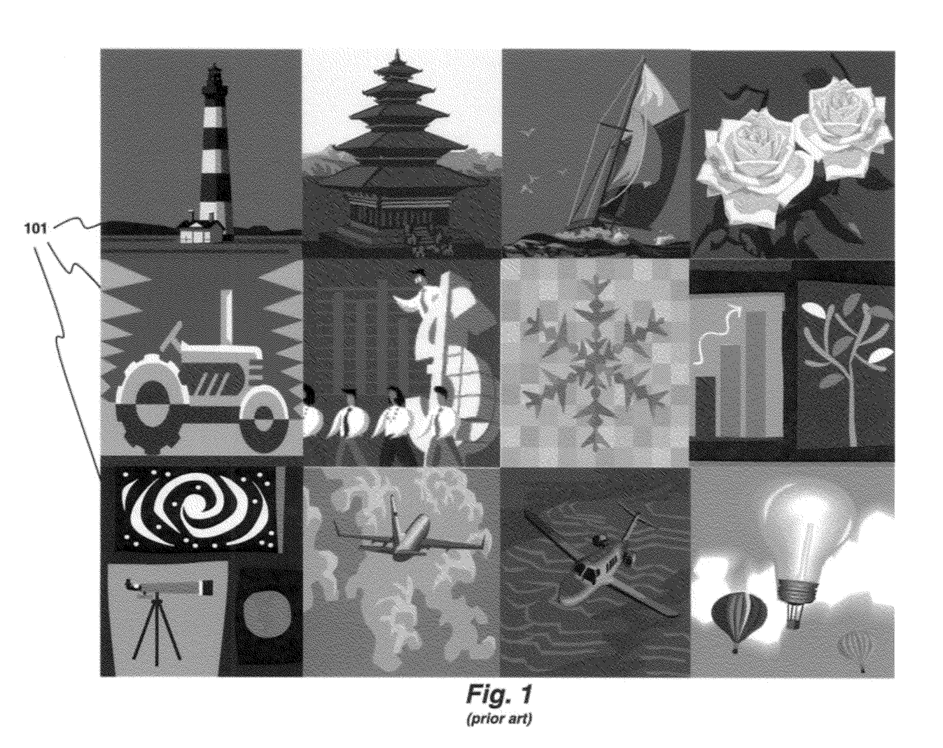

### DETAILED DESCRIPTION

In the following description, for the purposes of explanation, numerous specific details are set forth in order to provide a thorough understanding of the embodiments of the invention described below. It will be apparent, however, to one skilled in the art that the embodiments of the invention may be practiced without some of these specific details. In other instances, well-known structures and devices are shown in block diagram form to avoid obscuring the underlying principles of the embodiments of the invention.

One embodiment of the invention comprises an interactive screen saver which, rather than terminating upon detecting user input, provides various types of interactive functionality. Specifically, in one embodiment, the interactive screen saver is designated as “mouse interactive” and/or “keyboard interactive,” allowing the user to interact with the screen saver via the mouse and/or keyboard, respectively. For keyboard interactive implementations, certain designated keys may be used for interaction while other keys (e.g., the ESC key) may be used to terminate the screen saver. In one specific implementation, the interactive screen saver creates images of album art and allows the user to select an album using the mouse and/or keyboard. In response to user selection of a particular album, a playlist for that album is automatically generated and played. Similarly, in one embodiment, the screen saver comprises a photo slideshow using the user's photo collection. The user select a particular photo from within the interactive screen saver to perform interactive operations such as opening a photo application, pausing the slideshow, and/or jumping between photos in the slideshow. As described below, various other implementations are contemplated within the scope of the present invention including, by way of example and not limitation, interactive videos, interactive calendars, and interactive messaging (e.g., new instant messages or email messages may be displayed and/or responded to).

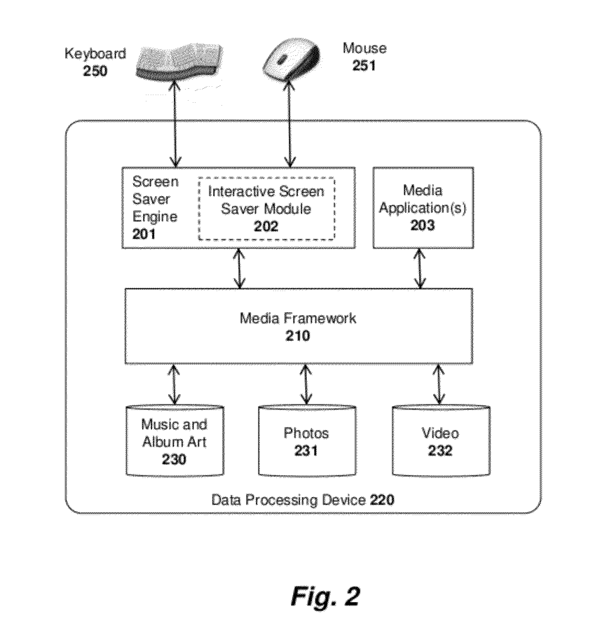

As illustrated in FIG. 2, a system architecture according to one embodiment of the invention comprises a screen saver engine 201 with an interactive screen saver module 202. The screen saver engine 201 includes program code used for all screen savers installed on the data processing device 220 and the interactive screen saver module 202 comprises the additional program code and logic for implementing the specific types of interactive functionality described herein. The interactive screen saver module 202 receives input from a keyboard 250 and/or mouse 251 and responsively performs interactive screen saver operations. As illustrated, in one embodiment, the interactive screen saver module 202 is provided with access to various types of user content via a media framework 210 executed on the user's computer (or other type of computing device). By way of example, and not limitation, the user content may include a user's music collection and album art 230, photos 231, video 232, and/or various other types of user data to be utilized by the interactive screen saver module 202.

In one specific embodiment, the computer system is a Macintosh™ or MacBook™ running a version of the OS X operating system. In this implementation, the media framework 210 may be the iLife Media Browser Framework designed by Apple Inc.™, the assignee of the present application. Other media applications 203 may also access the user's content via the media framework. For example, the well known iTunes application (also designed by the assignee of the present application) accesses the user's music and album art 230 using the media framework. The interactive screen saver module 202 may communicate with the media applications 203 to access the user's content. For example, the interactive screen saver module 202 may communicate with media applications such as iTunes using AppleScript™, a well known scripting language designed by the assignee of the present application.

It should be noted, however, that the underlying principles of the invention are not limited to the specific implementations described above. Various different types of data processing devices and operating systems may be used including, but not limited to, portable data processing devices such as the iPhone, iPad, iPod Touch, and laptop computers.

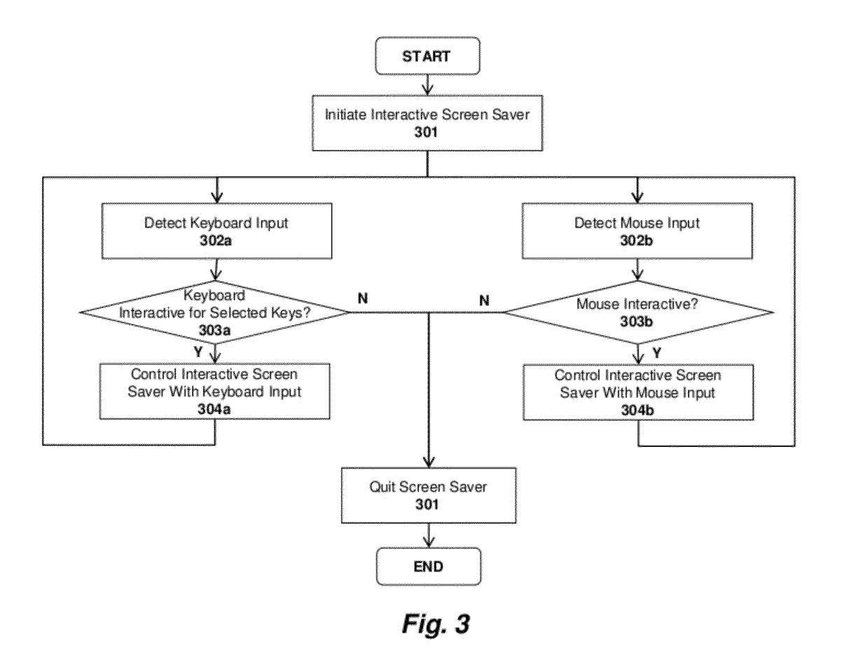

One embodiment of an interactive screen saver method is illustrated in FIG. 3. This method may be executed using the architecture shown in FIG. 2 but is not limited to any specific architecture. At 301, an interactive screen saver is initiated on the data processing device. This may occur, for example, after a specified amount of time of inactivity on the data processing device. Once initiated, the interactive screen saver listens for mouse input and/or specific keyboard key entries. Thus, at 302a, specific keyboard input is detected and at 303a, a determination is made as to whether the interactive screen saver is keyboard interactive with respect to the keys selected by the user. If so, then at 304a, the interactive screen saver is controlled using the keyboard input. If not (or if one or more non-interactive keys of the keyboard are selected, such as the ESC key), then at 301, the screen saver quits and the data processing device is returned to normal data processing operation.

Similarly, at 302b, mouse input is detected and, at 303b, a determination is made as to whether the screen saver is mouse interactive. If so, then at 304b, the interactive screen saver is controlled via the mouse. If not (or if a non-interactive mouse input is detected), then the screen saver quits at 301, and the data processing device returns to normal data processing operation.

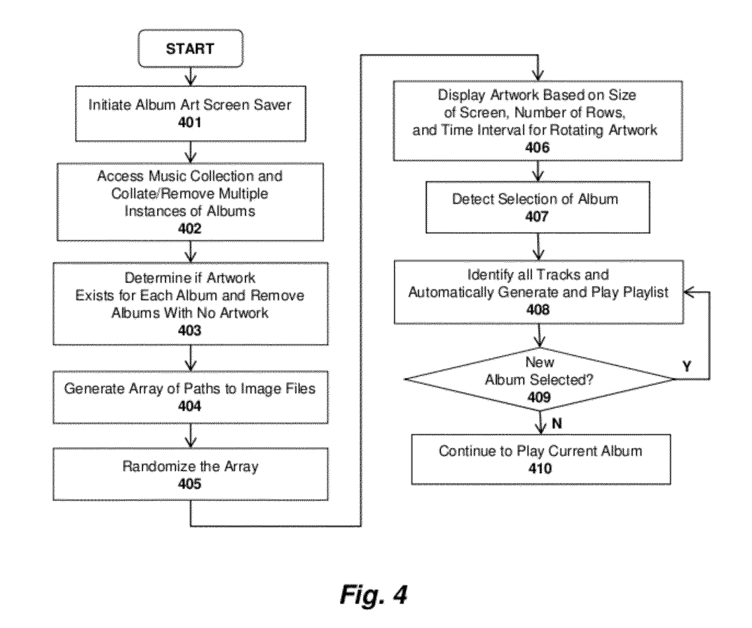

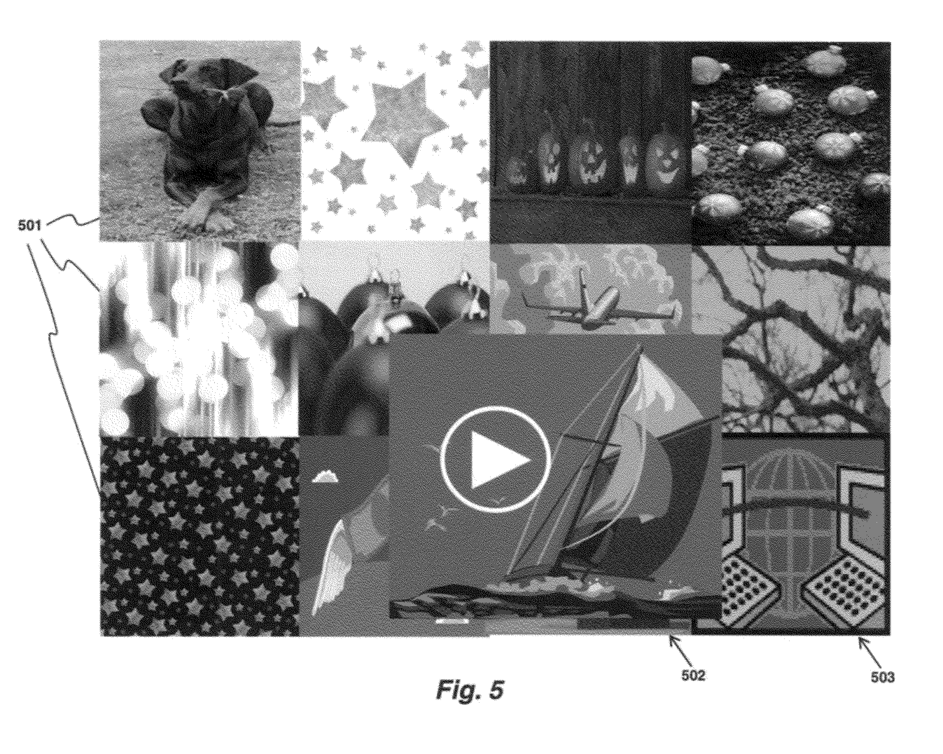

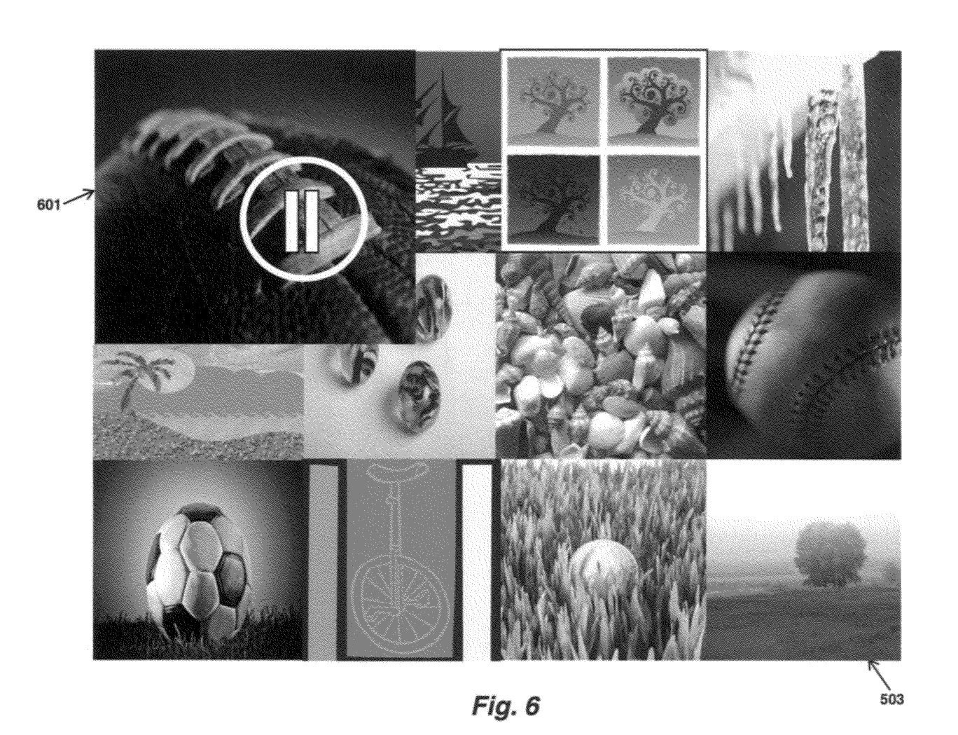

As previously mentioned, in one specific embodiment, the interactive screen saver creates images of album art and allows the user to select an album using the mouse and/or keyboard. One embodiment of a method for implementing this interactive screen saver is illustrated in FIG. 4, and an exemplary screen saver GUI is illustrated in FIGS. 5-6.

Turning first to FIG. 4, at 401, the album art screen saver is initiated (e.g., after a specified duration of inactivity). At 402, the user's music collection is accessed (e.g., via the media framework 210 described above), the user's albums are collated and/or multiple instances of the albums (e.g., duplicate albums) are removed. At 403, a determination is made as to whether artwork exists for each album and albums with no artwork are removed from use within the interactive screen saver (i.e., so that a generic album image such as the one used in iTunes is not displayed within the interactive screen saver).

At 404, an array is generated comprised of paths to each of the image artwork files. In one embodiment, the paths are simply file system links or URLs to the image files (e.g., JPEG images) on the user's local hard drive. In an iTunes implementation, the links may identify iTunes Cover Flow Data files (.itc files) which contain album artwork and metadata for songs and which are typically stored within the /Music/iTunes/Album Artwork/Local/directory.

Regardless of the particular format for the array of paths and art files, at 405, the array is randomized. That is, a first set of N album art images are randomly selected to fill N positions within the interactive screen saver. The value of N may be based on the number of rows of artwork displayed within the screen saver. As mentioned, this value may be configured by the end user.

At 406, the interactive screen saver displays the album artwork based on the size of the display screen and the number of rows of album art (e.g., as specified by the end user). The album images are then periodically swapped out with new images based on a time interval for rotating the artwork (which also may be specified by the end user). In one embodiment, a single, randomly selected album image is replaced with a new one at each time interval (e.g., every 2 seconds).

At 407, the selection of a particular album is detected. In one embodiment, the method shown in FIG. 3 is implemented to determine whether the user interaction will be performed with the keyboard, mouse or both. For example, in one embodiment, the user may move a selection cursor with a mouse or with control keys on the keyboard to select a particular album from the screen saver. Different graphics may be employed to identify selected albums (as discussed below). Once selected, at 408, all of the tracks associated with the album are used to generate a playlist (e.g., either a non-random or a random playlist). If a new album is selected, determined at 409, the tracks associated with the new album are used to generate a new playlist. If no new album is selected, then the current album continues to be highlighted and/or played at 410.

A graphical user interface for one embodiment of an interactive screen saver is illustrated in FIGS. 5-6. In this particular embodiment, a set of 12 album art images 501 are randomly selected and tiled together. As mentioned above, one of the 12 images may be swapped out for a new one periodically (e.g., every few seconds). In addition, in the example shown in FIG. 5, the user has selected a particular album 502 by mousing over the album image and/or selecting the album image using designated keys on the keyboard. In response, in this embodiment, the interactive screen saver enlarges the album art image 502 and displays a play graph in the center of the album art image 502. The user may then play tracks from the album without interrupting the screen saver by clicking on the album art image 502 using the mouse (or designated keys on the keyboard such as the Enter key). In addition, in one embodiment, an “exit” icon 503 is provided to allow the user to exit the interactive screen saver (e.g., by selecting the exit icon with the mouse and/or keyboard). In addition, certain designated keys or key combinations may be used to exit the screen saver (e.g., such as the ESC key).

In one embodiment, after selecting a particular album, the interactive screen saver plays tracks from the album (either in order or randomly), and the album art image 601 displays a pause icon, as illustrated in FIG. 6. In addition, in one embodiment, the artwork for the album being played is not swapped out with new album artwork while the album is played.

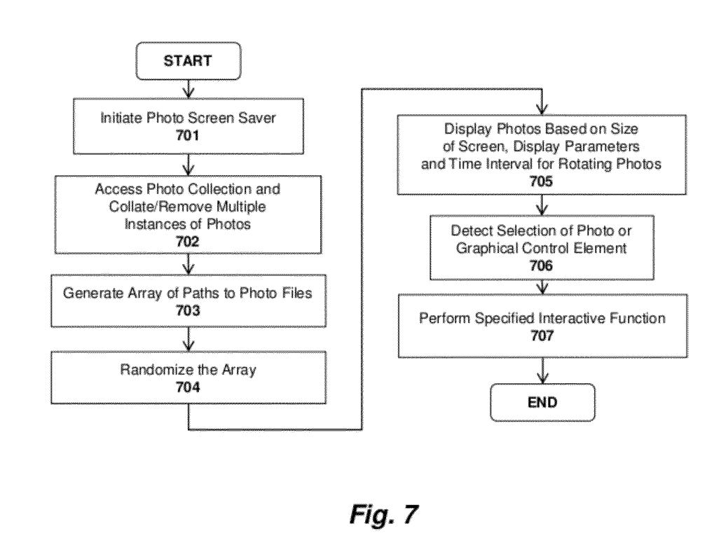

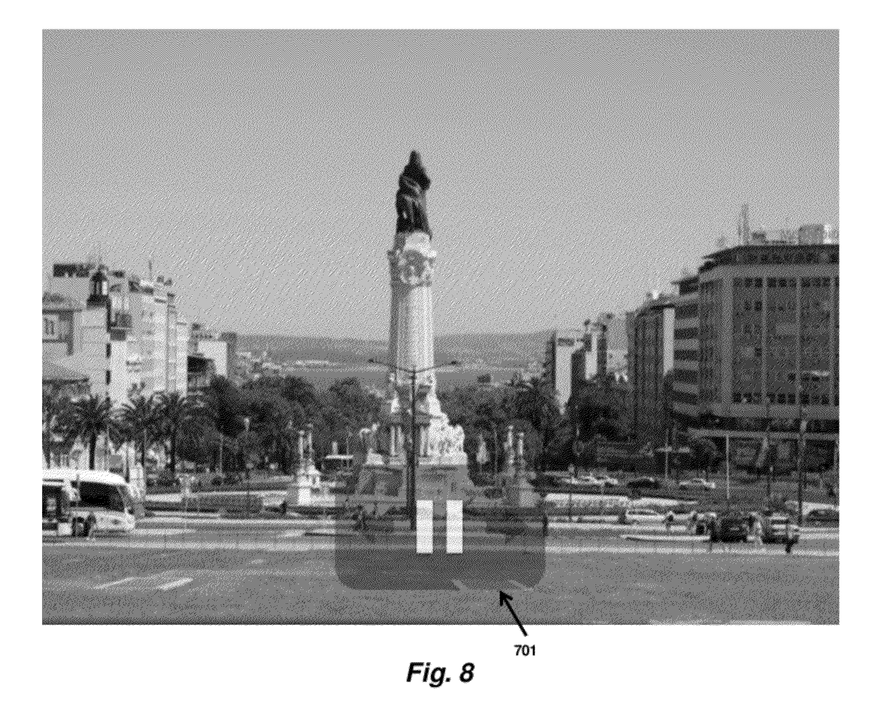

One embodiment of an interactive photo screen saver method is illustrated in FIG. 7 and GUI features of the interactive photo screen saver are illustrated in FIGS. 8-10. Turning first to the method of FIG. 7, at 701 the photo screen saver is initiated (e.g., after a specified duration of inactivity). At 702, the user's photo collection is accessed (e.g., via the media framework 210 described above), the user's photos are collated and/or multiple instances of the photos (e.g., duplicate photos) are removed. The foregoing step may not be needed in some implementations. At 703, an array is generated comprised of paths to each of the photo image files. In one embodiment, the paths are simply file system links or URLs to the image files (e.g., JPEG images) on the user's local hard drive.

Regardless of the particular format for the array of paths and photo image files, at 704, the array is randomized. That is, a first set of N images may be randomly selected to fill N positions within the interactive screen saver. The value of N may be based on the user-specified number of images displayed within the screen saver. In one particular embodiment, only a single image at a time is displayed, but the screen saver randomly and periodically displays new images (e.g., every few seconds).

At 705, the interactive screen saver displays the photos based on the size of the screen, user-specified display parameters (e.g., number of concurrent photos to be displayed). The photo images are then periodically swapped out with new images based on a time interval (which also may be specified by the end user). In one embodiment, a single, randomly selected photo image is replaced with a new one at each time interval (e.g., every 2 seconds).

At 706, the selection of a particular photo is detected. In one embodiment, the method shown in FIG. 3 is implemented to determine whether the user interaction will be performed with the keyboard, mouse or both. For example, in one embodiment, the user may move a selection cursor with a mouse or with control keys on the keyboard to select a particular photo from the screen saver. Different graphics may be employed to identify selected photos (as discussed below). Once selected, at 707, one or more specified interactive functions are performed. For example, in one embodiment, a photo application is launched and the photo is displayed within the photo application. In another embodiment, the user is provided with graphical elements to jump between photos, play and/or pause the rotation of the photos. Various other interactive functions may be employed while complying with the underlying principles of the invention.

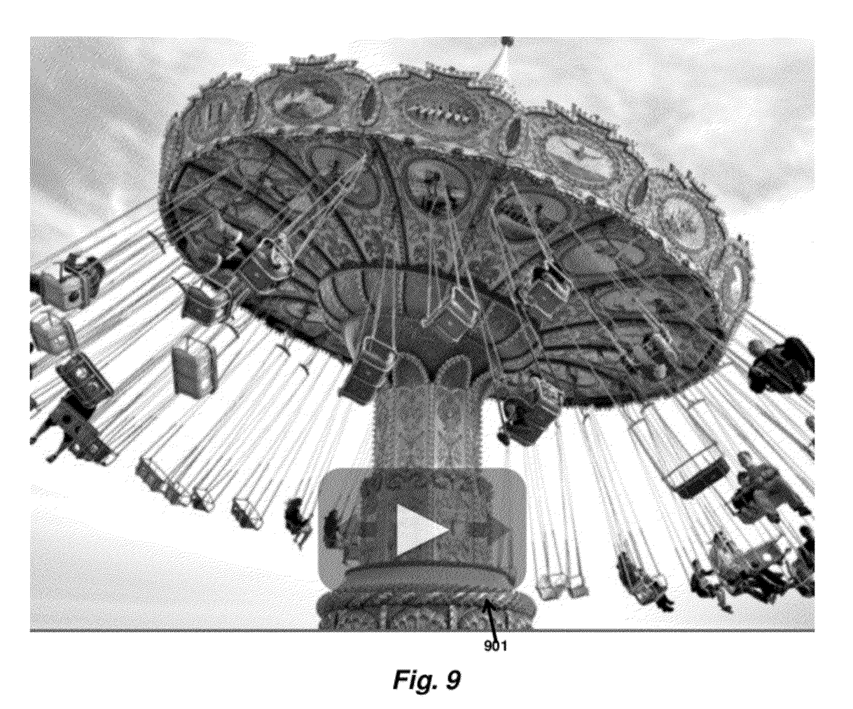

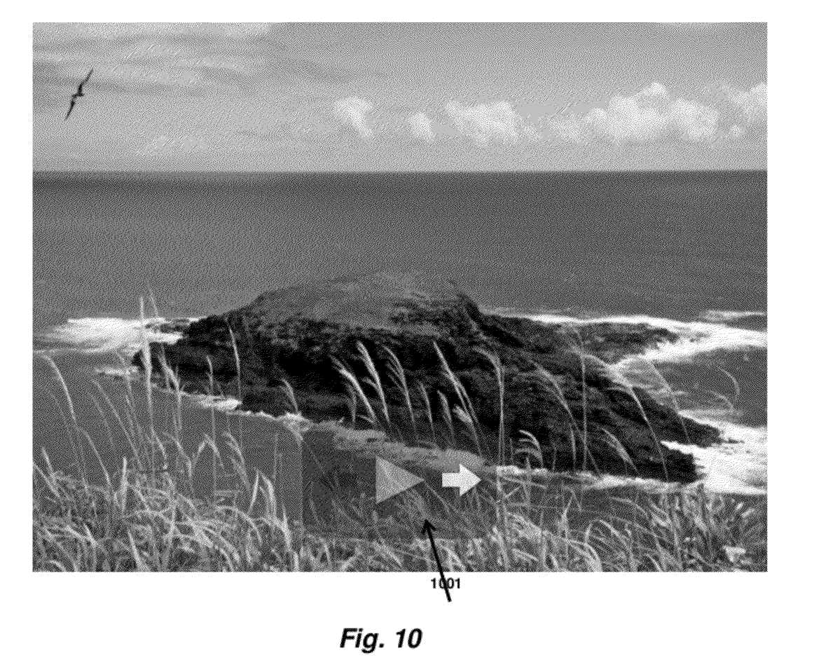

FIGS. 7-9 illustrate one embodiment of an interactive photo screen saver in which a single photo is displayed at a time. FIG. 8 illustrates a pause graphic 801 which, when selected using a mouse or keyboard, pauses the display of new photos. Similarly, FIG. 9 illustrates a play graphic 901 which, when selected using a mouse or keyboard, re-initiates the periodic display of new photos. FIG. 10 also shows a play graphic 1001 which includes fast forward and rewind elements to cause the interactive screen saver to jump forward to the next photo or backward to a previous photo.

The interactive screen saver techniques described above may be implemented with various other types of user data and media content while still complying with the underlying principles of the invention. For example, a user's video collection may be automatically displayed in a similar manner to the photo embodiments described above. In addition, entries from a user's calendar may be displayed and the user may interact with these entries within the interactive screen saver via a mouse and/or keyboard (e.g., to delete entries, update existing entries, add new entries, etc). Similarly, in one embodiment, new email messages or instant messages may be displayed within the interactive screen saver. In one embodiment, the interactive screen saver rotates through each of the content types and/or types of data described above.

Throughout the foregoing description, for the purposes of explanation, numerous specific details were set forth in order to provide a thorough understanding of the invention. It will be apparent, however, to one skilled in the art that the invention may be practiced without some of these specific details. For example, while the embodiments described above focus on music and photo content, the underlying principles of the invention are not limited to any particular type of content. Accordingly, the scope and spirit of the invention should be judged in terms of the claims below.

Some embodiments include one or more application programming interfaces (APIs) in an environment with calling program code interacting with other program code being called through the one or more interfaces. Various function calls, messages or other types of invocations, which further may include various kinds of parameters, can be transferred via the APIs between the calling program and the code being called. In addition, an API may provide the calling program code the ability to use data types or classes defined in the API and implemented in the called program code.

At least certain embodiments include an environment with a calling software component interacting with a called software component through an API. A method for operating through an API in this environment includes transferring one or more function calls, messages, other types of invocations or parameters via the API.

One or more Application Programming Interfaces (APIs) may be used in some embodiments. An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component.

An API allows a developer of an API-calling component (which may be a third party developer) to leverage specified features provided by an API-implementing component. There may be one API-calling component or there may be more than one such component. An API can be a source code interface that a computer system or program library provides in order to support requests for services from an application. An operating system (OS) can have multiple APIs to allow applications running on the OS to call one or more of those APIs, and a service (such as a program library) can have multiple APIs to allow an application that uses the service to call one or more of those APIs. An API can be specified in terms of a programming language that can be interpreted or compiled when an application is built.

In some embodiments the API-implementing component may provide more than one API, each providing a different view of or with different aspects that access different aspects of the functionality implemented by the API-implementing component. For example, one API of an API-implementing component can provide a first set of functions and can be exposed to third party developers, and another API of the API-implementing component can be hidden (not exposed) and provide a subset of the first set of functions and also provide another set of functions, such as testing or debugging functions which are not in the first set of functions. In other embodiments the API-implementing component may itself call one or more other components via an underlying API and thus be both an API-calling component and an API-implementing component.

An API defines the language and parameters that API-calling components use when accessing and using specified features of the API-implementing component. For example, an API-calling component accesses the specified features of the API-implementing component through one or more API calls or invocations (embodied for example by function or method calls) exposed by the API and passes data and control information using parameters via the API calls or invocations. The API-implementing component may return a value through the API in response to an API call from an API-calling component. While the API defines the syntax and result of an API call (e.g., how to invoke the API call and what the API call does), the API may not reveal how the API call accomplishes the function specified by the API call. Various API calls are transferred via the one or more application programming interfaces between the calling (API-calling component) and an API-implementing component. Transferring the API calls may include issuing, initiating, invoking, calling, receiving, returning, or responding to the function calls or messages; in other words, transferring can describe actions by either of the API-calling component or the API-implementing component. The function calls or other invocations of the API may send or receive one or more parameters through a parameter list or other structure. A parameter can be a constant, key, data structure, object, object class, variable, data type, pointer, array, list or a pointer to a function or method or another way to reference a data or other item to be passed via the API.

Furthermore, data types or classes may be provided by the API and implemented by the API-implementing component. Thus, the API-calling component may declare variables, use pointers to, use or instantiate constant values of such types or classes by using definitions provided in the API.

Generally, an API can be used to access a service or data provided by the API-implementing component or to initiate performance of an operation or computation provided by the API-implementing component. By way of example, the API-implementing component and the API-calling component may each be any one of an operating system, a library, a device driver, an API, an application program, or other module (it should be understood that the API-implementing component and the API-calling component may be the same or different type of module from each other). API-implementing components may in some cases be embodied at least in part in firmware, microcode, or other hardware logic. In some embodiments, an API may allow a client program to use the services provided by a Software Development Kit (SDK) library. In other embodiments an application or other client program may use an API provided by an Application Framework. In these embodiments the application or client program may incorporate calls to functions or methods provided by the SDK and provided by the API or use data types or objects defined in the SDK and provided by the API. An Application Framework may in these embodiments provide a main event loop for a program that responds to various events defined by the Framework. The API allows the application to specify the events and the responses to the events using the Application Framework. In some implementations, an API call can report to an application the capabilities or state of a hardware device, including those related to aspects such as input capabilities and state, output capabilities and state, processing capability, power state, storage capacity and state, communications capability, etc., and the API may be implemented in part by firmware, microcode, or other low level logic that executes in part on the hardware component.

The API-calling component may be a local component (i.e., on the same data processing system as the API-implementing component) or a remote component (i.e., on a different data processing system from the API-implementing component) that communicates with the API-implementing component through the API over a network. It should be understood that an API-implementing component may also act as an API-calling component (i.e., it may make API calls to an API exposed by a different API-implementing component) and an API-calling component may also act as an API-implementing component by implementing an API that is exposed to a different API-calling component.

The API may allow multiple API-calling components written in different programming languages to communicate with the API-implementing component (thus the API may include features for translating calls and returns between the API-implementing component and the API-calling component); however the API may be implemented in terms of a specific programming language. An API-calling component can, in one embedment, call APIs from different providers such as a set of APIs from an OS provider and another set of APIs from a plug-in provider and another set of APIs from another provider (e.g. the provider of a software library) or creator of the another set of APIs.

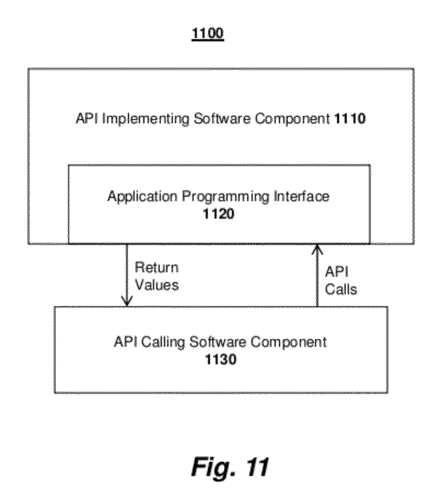

FIG. 11 is a block diagram illustrating an exemplary API architecture, which may be used in some embodiments of the invention. As shown in FIG. 11, the API architecture 1100 includes the API-implementing component 1110 (e.g., an operating system, a library, a device driver, an API, an application program, software or other module) that implements the API 1120. The API 1120 specifies one or more functions, methods, classes, objects, protocols, data structures, formats and/or other features of the API-implementing component that may be used by the API-calling component 1130. The API 1120 can specify at least one calling convention that specifies how a function in the API-implementing component receives parameters from the API-calling component and how the function returns a result to the API-calling component. The API-calling component 1130 (e.g., an operating system, a library, a device driver, an API, an application program, software or other module), makes API calls through the API 520 to access and use the features of the API-implementing component 510 that are specified by the API 1120. The API-implementing component 1110 may return a value through the API 1120 to the API-calling component 1130 in response to an API call.

It will be appreciated that the API-implementing component 510 may include additional functions, methods, classes, data structures, and/or other features that are not specified through the API 1120 and are not available to the API-calling component 1130. It should be understood that the API-calling component 1130 may be on the same system as the API-implementing component 1110 or may be located remotely and accesses the API-implementing component 1110 using the API 1120 over a network. While FIG. 11 illustrates a single API-calling component 1130 interacting with the API 1120, it should be understood that other API-calling components, which may be written in different languages (or the same language) than the API-calling component 1130, may use the API 1120.

The API-implementing component 1110, the API 1120, and the API-calling component 1130 may be stored in a tangible machine-readable storage medium, which includes any mechanism for storing information in a form readable by a machine (e.g., a computer or other data processing system). For example, a tangible machine-readable storage medium includes magnetic disks, optical disks, random access memory (e.g. DRAM); read only memory, flash memory devices, etc.

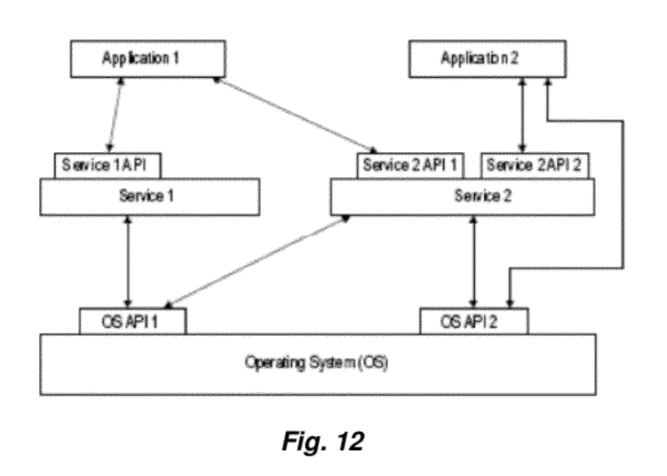

In FIG. 12 (“Software Stack”), an exemplary embodiment, applications can make calls to Services A or B using several Service APIs and to Operating System (OS) using several OS APIs. Services A and B can make calls to OS using several OS APIs.

Note that the Service 2 has two APIs, one of which (Service 2 API 1) receives calls from and returns values to Application 1 and the other (Service 2 API 2) receives calls from and returns values to Application 2. Service 1 (which can be, for example, a software library) makes calls to and receives returned values from OS API 1, and Service 2 (which can be, for example, a software library) makes calls to and receives returned values from both OS API 1 and OS API 2. Application 2 makes calls to and receives returned values from OS API 2.

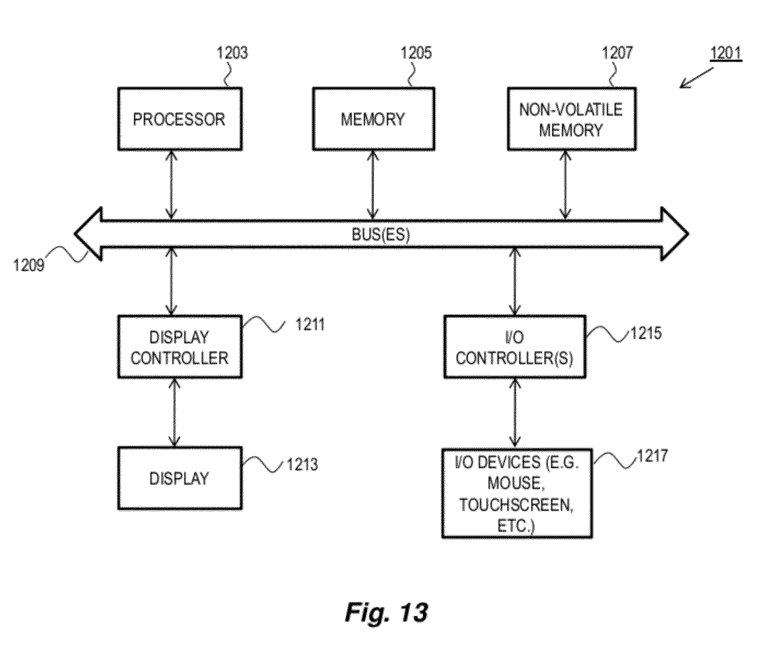

Any one of the methods described herein can be implemented on a variety of different data processing devices, including general purpose computer systems, special purpose computer systems, etc. For example, the data processing systems which may use any one of the methods described herein may include a desktop computer or a laptop computer or a tablet computer or a smart phone, or a cellular telephone, or a personal digital assistant (PDA), an embedded electronic device or a consumer electronic device. FIG. 13 shows one example of a typical data processing system which may be used with the present invention. Note that while FIG. 13 illustrates the various components of a data processing system, such as a computer system, it is not intended to represent any particular architecture or manner of interconnecting the components as such details are not germane to the present invention. It will also be appreciated that other types of data processing systems which have fewer components than shown or more components than shown in FIG. 13 may also be used with the present invention. The data processing system of FIG. 13 may be a Macintosh computer from Apple Inc. of Cupertino, California. As shown in FIG. 13, the data processing system 1301 includes one or more buses 709 which serve to interconnect the various components of the system. One or more processors 1303 are coupled to the one or more buses 1309 as is known in the art. Memory 1305 may be DRAM or non-volatile RAM or may be flash memory or other types of memory. This memory is coupled to the one or more buses 1309 using techniques known in the art. The data processing system 1301 can also include non-volatile memory 1307 which may be a hard disk drive or a flash memory or a magnetic optical drive or magnetic memory or an optical drive or other types of memory systems which maintain data even after power is removed from the system. The non-volatile memory 1307 and the memory 1305 are both coupled to the one or more buses 1309 using known interfaces and connection techniques. A display controller 1311 is coupled to the one or more buses 709 in order to receive display data to be displayed on a display device 1313 which can display any one of the user interface features or embodiments described herein. The display device 1313 can include an integrated touch input to provide a touch screen. The data processing system 1301 can also include one or more input/output (I/O) controllers 1315 which provide interfaces for one or more I/O devices, such as one or more mice, touch screens, touch pads, joysticks, and other input devices including those known in the art and output devices (e.g. speakers). The input/output devices 1317 are coupled through one or more I/O controllers 1315 as is known in the art. While FIG. 13 shows that the non-volatile memory 1307 and the memory 1305 are coupled to the one or more buses directly rather than through a network interface, it will be appreciated that the data processing system may utilize a non-volatile memory which is remote from the system, such as a network storage device which is coupled to the data processing system through a network interface such as a modem or Ethernet interface or wireless interface, such as a wireless WiFi transceiver or a wireless cellular telephone transceiver or a combination of such transceivers. As is known in the art, the one or more buses 1309 may include one or more bridges or controllers or adapters to interconnect between various buses. In one embodiment, the I/O controller 1315 includes a USB adapter for controlling USB peripherals and can control an Ethernet port or a wireless transceiver or combination of wireless transceivers. It will be apparent from this description that aspects of the present invention may be embodied, at least in part, in software. That is, the techniques and methods described herein may be carried out in a data processing system in response to its processor executing a sequence of instructions contained in a tangible, non-transitory memory such as the memory 1305 or the non-volatile memory 1307 or a combination of such memories, and each of these memories is a form of a machine readable, tangible storage medium. In various embodiments, hardwired circuitry may be used in combination with software instructions to implement the present invention. Thus the techniques are not limited to any specific combination of hardware circuitry and software nor to any particular source for the instructions executed by the data processing system.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. An interactive screen saver method comprising:
initiating a screen saver on a data processing device;
detecting keyboard input and/or mouse input on the data processing device while the screen saver is running;
determining whether the screen saver is a keyboard interactive and/or a mouse interactive screen saver;
if the interactive screen saver is keyboard interactive and/or mouse interactive, then performing interactive operations within the interactive screen saver in response to user input entered from the keyboard and/or mouse, respectively without quitting the screen saver; and
if the interactive screen saver is not keyboard and/or mouse interactive, then quitting the interactive screen saver in response to detecting the keyboard input and/or mouse input.

2. The method as in claim 1 wherein initiating the screen saver comprises:
reading album art from a storage device, the album art comprising a plurality of images, each of the images associated with a particular album in a user's music collection; and
displaying the album art within the screen saver.

3. The method as in claim 2 wherein the album art is displayed based on the size of the data processing device's display screen, a predetermined number of rows of album art to be displayed, and/or a time interval for rotating the album art.

4. The method as in claim 2 further comprising:
detecting that the user has selected a particular album art image from the screen saver; and
playing one or more tracks from an album with which the album art image is associated.

5. The method as in claim 4 further comprising:
in response to a user moving a graphical cursor over a particular album art image, highlighting the image and/or generating a play graphic associated with the image.

6. The method as in claim 5 further comprising:
in response to the user selecting the particular album art image, thereby causing the one or more tracks to be played, generating a pause graphic associated with the image, wherein selection of the pause graphic pauses playback of the one or more tracks.

7. A method for an interactive multimedia screen saver comprising:
initiating a multimedia screen saver;
responsively displaying one or more graphical images, each graphical image representing particular multimedia content stored on a storage device;
detecting that a user has selected a particular graphical image from the screen saver by manipulating a mouse or keyboard; and
responsively playing the multimedia content represented by the selected graphical image.

8. The method as in claim 7 wherein the multimedia content is played without quitting the multimedia screen saver.

9. The method as in claim 7 wherein the multimedia content comprises music content, and wherein the graphical images comprise album art associated with albums in the user's music collection.

10. The method as in claim 9 wherein displaying the album art comprises:
determining if album artwork exists for each album in the user's music collection;
removing albums from use within the multimedia screen saver for which no album art exists; and
generating an array of paths linking each of the displayed album art images within the multimedia screen saver to music albums associated with each of the album art images.

11. The method as in claim 9 further comprising:
displaying the album art within the multimedia screen saver based on a number of rows specified by the end user for displaying the album art.

12. The method as in claim 9 further comprising:
periodically and randomly selecting new album art to be displayed within the multimedia screen saver.

13. The method as in claim 9 wherein, in response to the user selecting a particular album art image, playing one or more audio tracks from an album identified by the album art image.

14. The method as in claim 13 further comprising:
displaying a pause graphic over the album art image as the one or more audio tracks are displayed, the pause graphic to indicate that the user may pause playback of the one or more tracks by selecting the pause graphic.

15. The method as in claim 14 further comprising:
highlighting a particular album art image in response to the user moving a graphical cursor over the album art image using a mouse or keyboard; and
displaying a play graphic associated with the album art image to indicate that the album associated with the album art image will be played in response to selection by the user.

16. The method as in claim 7 wherein the multimedia content comprises photos, and wherein the graphical images comprise photo images from the user's photo collection.

17. The method as in claim 16 wherein, in response to a user selecting a particular photo image from within the interactive multimedia screen saver, performing a specified interactive function associated with the particular photo image.

18. The method as in claim 17 wherein the specified interactive function comprises pausing a slideshow, initiating a slideshow and/or opening the selected photo in a photo application.

19. A machine-readable medium having program code stored thereon which, when executed by a processor, causes the processor to perform the operations of:
initiating a screen saver on a data processing device;
detecting keyboard input and/or mouse input on the data processing device while the screen saver is running;
determining whether the screen saver is a keyboard interactive and/or a mouse interactive screen saver;
if the interactive screen saver is keyboard interactive and/or mouse interactive, then performing interactive operations within the interactive screen saver in response to user input entered from the keyboard and/or mouse, respectively without quitting the screen saver; and
if the interactive screen saver is not keyboard and/or mouse interactive, then quitting the interactive screen saver in response to detecting the keyboard input and/or mouse input.

20. The machine-readable medium as in claim 19 wherein initiating the screen saver comprises:
reading album art from a storage device, the album art comprising a plurality of images, each of the images associated with a particular album in a user's music collection; and
displaying the album art within the screen saver.

21. The machine-readable medium as in claim 20 wherein the album art is displayed based on the size of the data processing device's display screen, a predetermined number of rows of album art to be displayed, and/or a time interval for rotating the album art.

22. The machine-readable medium as in claim 20 comprising additional program code to cause the processor to perform the operations of:
detecting that the user has selected a particular album art image from the screen saver; and
playing one or more tracks from an album with which the album art image is associated.

23. The machine-readable medium as in claim 22 comprising additional program code to cause the processor to perform the operations of:
in response to a user moving a graphical cursor over a particular album art image, highlighting the image and/or generating a play graphic associated with the image.

24. The machine-readable medium as in claim 23 comprising additional program code to cause the processor to perform the operations of:
in response to the user selecting the particular album art image, thereby causing the one or more tracks to be played, generating a pause graphic associated with the image, wherein selection of the pause graphic pauses playback of the one or more tracks.

25. A machine-readable medium having program code stored thereon which, when executed by a processor, causes the processor to perform the operations of:
initiating a multimedia screen saver;
responsively displaying one or more graphical images, each graphical image representing particular multimedia content stored on a storage device;
detecting that a user has selected a particular graphical image from the screen saver by manipulating a mouse or keyboard; and
responsively playing the multimedia content represented by the selected graphical image.

26. The machine-readable medium as in claim 25 wherein the multimedia content is played without quitting the multimedia screen saver.

27. The machine-readable medium as in claim 25 wherein the multimedia content comprises music content, and wherein the graphical images comprise album art associated with albums in the user's music collection.

28. The machine-readable medium as in claim 27 wherein displaying the album art comprises:
determining if album artwork exists for each album in the user's music collection;
removing albums from use within the multimedia screen saver for which no album art exists; and
generating an array of paths linking each of the displayed album art images within the multimedia screen saver to music albums associated with each of the album art images.

29. The machine-readable medium as in claim 27 comprising additional program code to cause the processor to perform the operations of:
displaying the album art within the multimedia screen saver based on a number of rows specified by the end user for displaying the album art.

30. The machine-readable medium as in claim 27 further comprising:
periodically and randomly selecting new album art to be displayed within the multimedia screen saver.

31. The machine-readable medium as in claim 27 wherein, in response to the user selecting a particular album art image, playing one or more audio tracks from an album identified by the album art image.

32. The machine-readable medium as in claim 31 further comprising:
displaying a pause graphic over the album art image as the one or more audio tracks are displayed, the pause graphic to indicate that the user may pause playback of the one or more tracks by selecting the pause graphic.

33. The machine-readable medium as in claim 32 further comprising:
highlighting a particular album art image in response to the user moving a graphical cursor over the album art image using a mouse or keyboard; and
displaying a play graphic associated with the album art image to indicate that the album associated with the album art image will be played in response to selection by the user.

34. The machine-readable medium as in claim 25 wherein the multimedia content comprises photos, and wherein the graphical images comprise photo images from the user's photo collection.

35. The machine-readable medium as in claim 34 wherein, in response to a user selecting a particular photo image from within the interactive multimedia screen saver, performing a specified interactive function associated with the particular photo image.

36. The machine-readable medium as in claim 35 wherein the specified interactive function comprises pausing a slideshow, initiating a slideshow and/or opening the selected photo in a photo application.
